(19) United States
(12) Patent Application Publication
(10) Pub. No.: US 2018/0283533 A1
(43) Pub. Date: Oct. 4, 2018

(54) CONTROL DEVICE UNIT INSTALLATION STRUCTURE FOR TRANSMISSION

(71) Applicant: Honda Motor Co.,Ltd., Tokyo (JP)

(72) Inventors: Hirotake OMOTO, Saitama (JP); Shunsuke YOSHIDA, Saitama (JP); Hirotaka YOKOTA, Saitama (JP)

(73) Assignee: Honda Motor Co.,Ltd., Tokyo (JP)

(21) Appl. No.: 15/916,290

(22) Filed: Mar. 9, 2018

(30) Foreign Application Priority Data
Mar. 31, 2017 (JP) 2017-071008

(51) Int. Cl. F16H 61/00; F16H 57/03

(52) U.S. Cl. CPC F16H 61/0006; F16H 2700/00; F16H 57/03

(57) ABSTRACT

Provided is a control device unit installation structure for a transmission in which wear of a terminal of a control device unit electrically connected to a lumped coupler is suppressed when the control device unit is fixed to a cover constituting a part of an outer wall of a transmission. In the control device unit installation structure for a transmission (1) in which a control device unit (60) of the transmission (1) of a vehicle is directly mounted on an outer wall of the transmission (1) and a harness connected to a functional part inside the transmission (1) is electrically connected to the control device unit (60), the control device unit (60) is installed on one cover (12) forming a part of the outer wall, and the harness is coupled to the controller device unit (60) on the one cover (12) via a lumped coupler installed in the transmission (1).

### CROSS-REFERENCE TO RELATED APPLICATION

This application claims the priority benefit of Japan Application no. 2017-071008, filed on Mar. 31, 2017. The entirety of the above-mentioned patent application is hereby incorporated by reference herein and made a part of this specification.

### BACKGROUND

### Technical Field

The disclosure relates to a control device unit installation structure for a transmission.

### Description of Related Art

Conventionally, a vehicle such as an automobile includes a control device unit of a transmission which controls a transmission installed in a vehicle. For example, the control device unit is mounted on an upper surface of a valve body installed inside an oil pan in a vehicle (refer to, for example, Patent Document 1).

One end of a harness is electrically connected to each part of the transmission, and the other end of the harness converges to a lumped coupler. For example, the lumped coupler is fixed to a control body of the transmission. Further, the control device unit is not limited to the case of being fixed on the upper surface of a valve body installed inside an oil pan in a vehicle as described in the above-mentioned patent document and may be fixed to another part, for example, a cover forming a part of an outer wall of the transmission and then may be connected to the lumped coupler.

[Patent Document 1] Japanese Unexamined Patent Application Publication No. 2011-252549

### SUMMARY

However, when the control device unit is fixed to the cover forming a part of the outer wall of the transmission, as described above, wear of a terminal of the control device unit electrically connected to the lumped coupler increases.

The disclosure has been made in view of the problems of the related art, and it is an object of the disclosure to provide a control device unit installation structure for a transmission in which wear of a terminal of a control device unit electrically connected to a lumped coupler is minimized when the control device unit is fixed to a cover constituting a part of an outer wall of a transmission.

(1) The disclosure provides a control device unit installation structure for a transmission (for example, an automatic transmission 1 which will be described later) in which a control device unit (for example, a TCU 60 which will be described later) of the transmission of a vehicle is directly mounted on an outer wall (for example, a casing 10 which will be described later) of the transmission and a harness (for example, a harness 104 which will be described later) connected to a functional part inside the transmission is electrically connected to the control device unit, wherein the control device unit is installed on one cover (for example, a casing cover portion 12 which will be described later) forming a part of the outer wall, and the harness is coupled to the controller device unit on the one cover via a lumped coupler (for example, a lumped coupler 105 which will be described later) installed in the transmission.

In the control device unit installation structure for a transmission described in (1), it is possible to electrically connect the lumped coupler to the control device unit without using the harness. Therefore, the harness is covered with the cover, and it is possible to protect the harness from flying stones or the like.

(2) In the control device unit installation structure for a transmission described in (1), reinforcing ribs (for example, ribs 121 and ribs 122 which will be described later) of the cover may be formed on at least one of an inner surface and an outer surface of the cover.

In the control device unit installation structure for a transmission described in (2), it is possible to increase a rigidity of the cover. Therefore, the control device unit fixed to the cover is prevented from greatly vibrating together with the cover. Accordingly, it is possible to suppress wear of a terminal of the control device unit connected to the lumped coupler vibrating together with the transmission due to film surface vibration of the cover.

(3) In the control device unit installation structure for a transmission described in (2), the reinforcing ribs formed on the outer surface of the cover may constitute heat radiating ribs of the cover.

In the control device unit installation structure for a transmission described in (3), it is possible to efficiently discharge heat in an inner space of the outer wall outside of the cover. In particular, for example, by providing the cover on the opening portion which opens in a forward direction of the vehicle at a front portion of the wall portion, air flowing from a front of the vehicle to a rear thereof easily flows through the ribs, and thus an effective cooling effect can be obtained.

(4) In the control device unit installation structure for a transmission described in (2), the reinforcing ribs formed on the inner surface of the cover may constitute ribs for gas-liquid separation of lubricating oil and/or ribs configured to prevent blowing-up.

In the control device unit installation structure for a transmission described in (4), it is possible to lengthen a time during which the lubricating oil scraped up by the transmission and containing air flows along the inner surface of the wall portion, and it is also possible to reduce an amount of air mixed into the lubricating oil. Further, for example, since the air mixed into the lubricating oil comes in contact with the ribs before directly flowing into a breather device, it is possible to promote gas-liquid separation of the lubricating oil mixed with the air. Therefore, occurrence of so-called breather blowing is effectively suppressed, and breather robustness can be improved.

According to the disclosure, it is possible to provide a control device unit installation structure for a transmission in which wear of the terminal of the control device unit electrically connected to the lumped coupler is suppressed when the control device unit is fixed to the cover forming a part of the outer wall of the transmission.

### BRIEF DESCRIPTION OF THE DRAWINGS

FIGS. 1(a)-1(c) are schematic views illustrating a vehicle with a control device unit installation structure for a transmission according to one embodiment of the disclosure, wherein FIG. 1(a) is a plan view, FIG. 1(b) is a front view, and FIG. 1(c) is a bottom view thereof.

FIG. 2 is a perspective view illustrating an automatic transmission with a control device unit installation structure for a transmission according to one embodiment of the disclosure.

FIG. 3 is an exploded perspective view illustrating the automatic transmission with the control device unit installation structure for a transmission according to one embodiment of the disclosure.

FIG. 4 is a front view illustrating the automatic transmission with the control device unit installation structure for a transmission according to one embodiment of the disclosure.

FIG. 5 is a front view illustrating a casing cover portion of the automatic transmission with the control device unit installation structure for a transmission according to one embodiment of the disclosure.

FIG. 6 is a rear view illustrating the casing cover portion of the automatic transmission with the control device unit installation structure for a transmission according to one embodiment of the disclosure.

FIG. 7 is a cross-sectional view taken along line A-A of FIG. 4.

FIG. 8 is an enlarged cross-sectional view illustrating the automatic transmission with the control device unit installation structure for a transmission according to one embodiment of the disclosure.

FIG. 9 is a rear view illustrating a state before the casing cover portion and a TCU of the automatic transmission with the control device unit installation structure for a transmission according to one embodiment of the disclosure are installed.

FIG. 10 is a rear view illustrating a state in which the casing cover portion is installed in the automatic transmission with the control device unit installation structure for a transmission according to one embodiment of the disclosure but the TCU is not yet installed.

### DESCRIPTION OF THE EMBODIMENTS

Hereinafter, an embodiment of the disclosure will be described below with reference to the drawings.

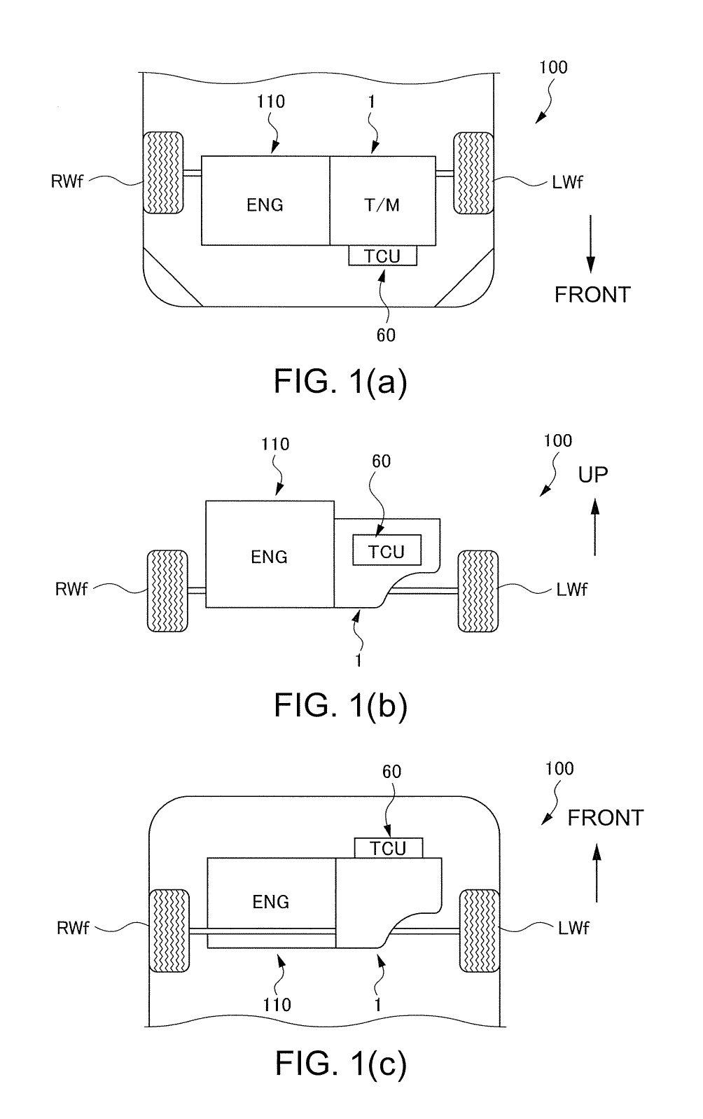

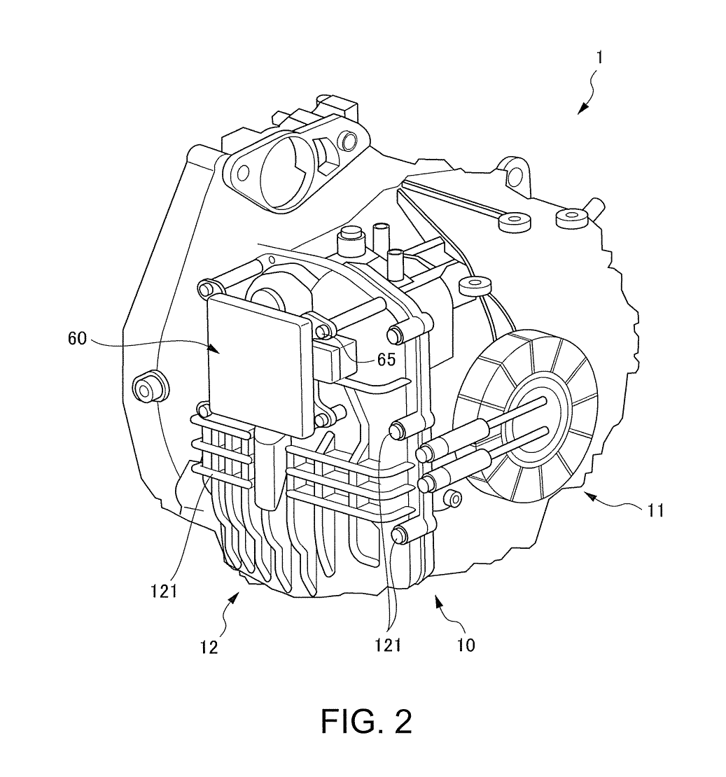

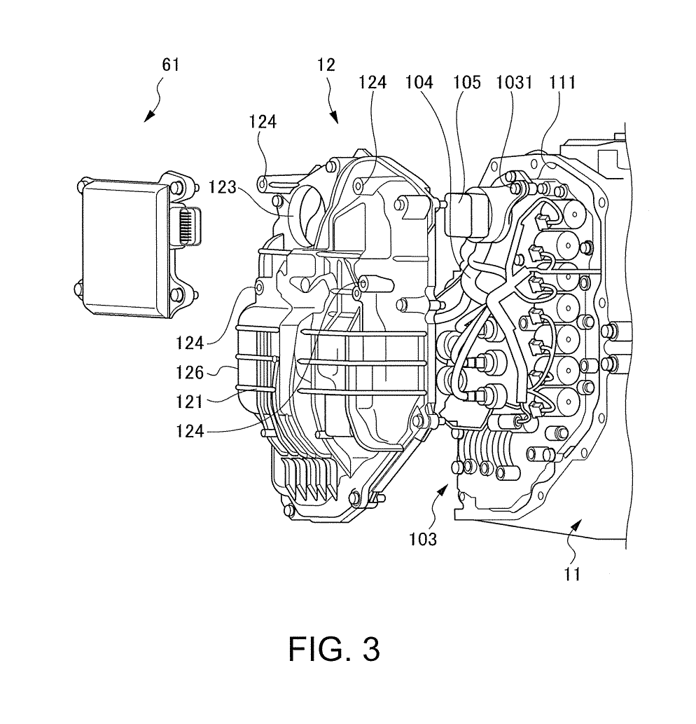

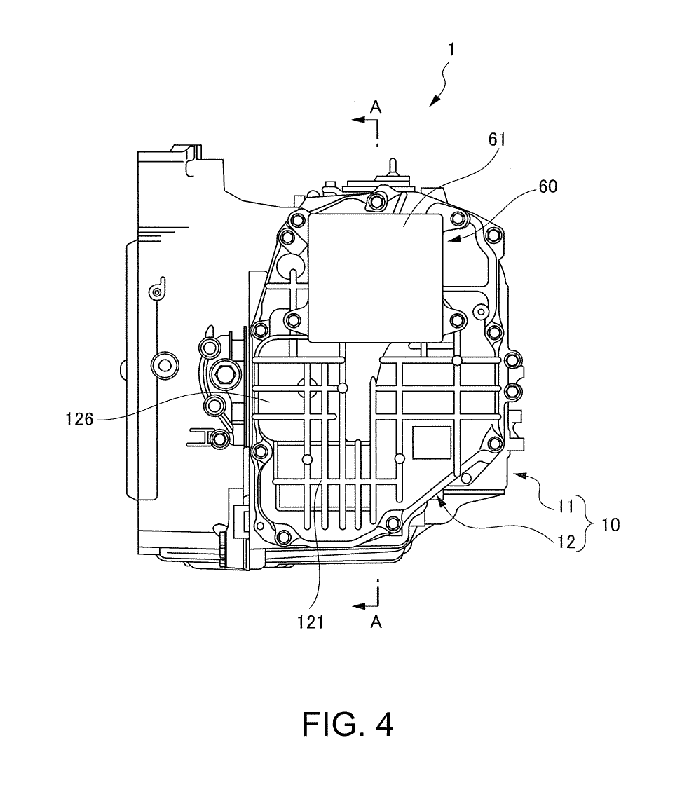

FIGS. 1(a)-1(c) are schematic views illustrating a vehicle 100 with a control device unit installation structure for a transmission according to one embodiment of the disclosure, wherein FIG. 1(a) is a plan view, FIG. 1(b) is a front view, and FIG. 1(c) is a bottom view thereof. FIG. 2 is a perspective view illustrating an automatic transmission 1 with a control device unit installation structure for a transmission according to one embodiment of the disclosure. FIG. 3 is an exploded perspective view illustrating the automatic transmission 1 with the control device unit installation structure for a transmission according to one embodiment of the disclosure. FIG. 4 is a front view illustrating the automatic transmission 1 with the control device unit installation structure for a transmission according to one embodiment of the disclosure.

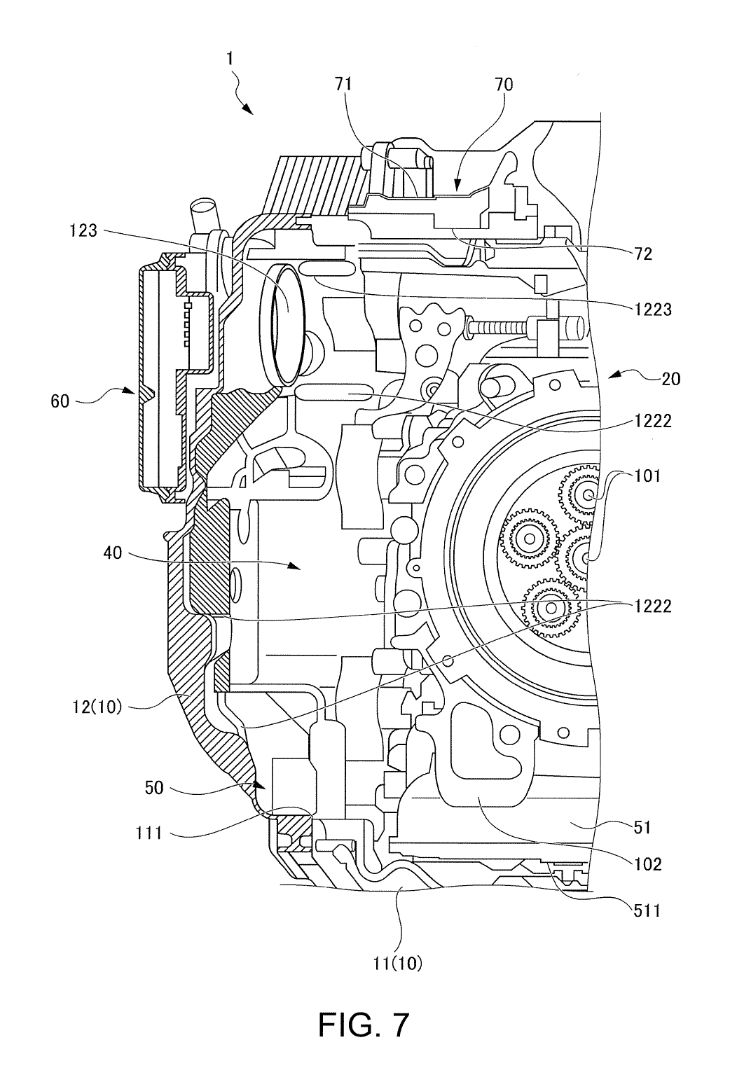

The control device unit installation structure for a transmission is included in the automatic transmission 1 which transmits a torque of an internal combustion engine (ENG) of the vehicle 100 to front wheels RWf and LWf. As illustrated in FIGS. 1(a)-1(c), the automatic transmission 1 is disposed on a left side (right side in FIGS. 1(a)-1(c)) of an internal combustion engine 110 to be adjacent to the internal combustion engine 110. The automatic transmission 1 includes a plurality of rotating shafts 101 (refer to FIG. 7) disposed parallel to each other, a transmission mechanism 20 which includes rotating parts such as a gear rotatably supported around each of the rotating shafts 101 and gear changing parts such as a clutch (not illustrated), and a casing 10 forming an outer wall of the transmission mechanism 20 which accommodates components of the automatic transmission 1 including the transmission mechanism 20.

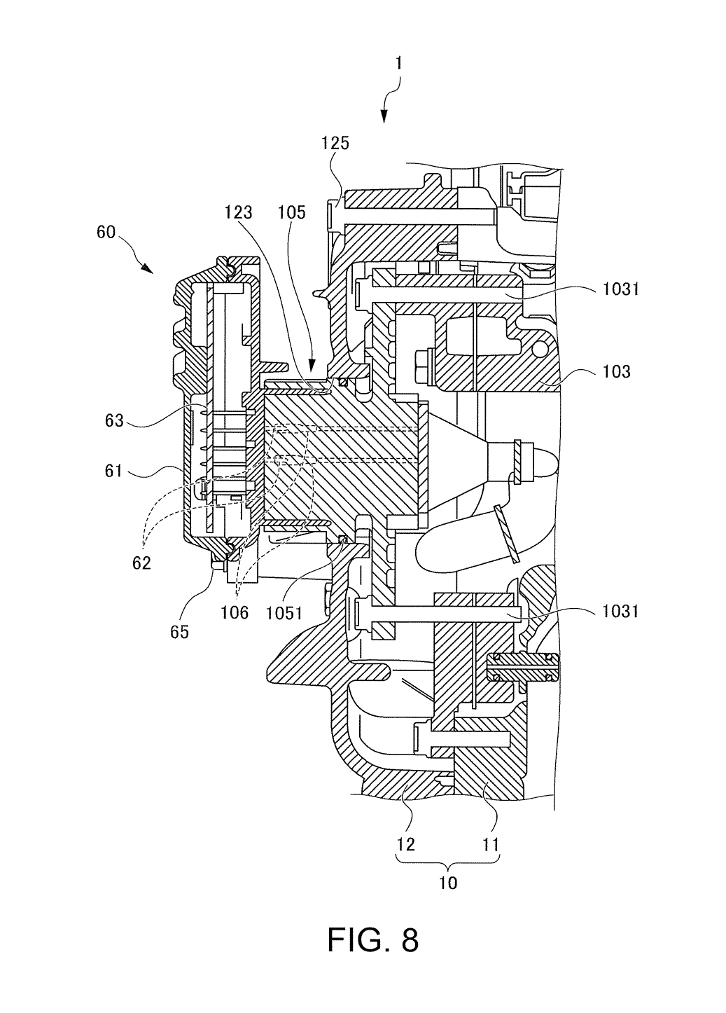

As illustrated in FIG. 7, an internal space of the casing 10 includes a machinery compartment 40 in which the transmission mechanism 20 is mainly accommodated, and an oil pan compartment 50 in which an automatic transmission fluid (ATF) present at a bottom portion of the casing 10 and in the vicinity thereof on a lower side of the machinery compartment 40 accumulates. The casing 10 has a casing wall portion 11 and a casing cover portion 12. The casing wall portion 11 is defined by a wall portion forming the internal space of the casing 10. An opening portion 111 which opens in a forward direction of the vehicle 100 and communicates with the internal space of the casing 10 is formed in a front portion of the casing wall portion 11. As illustrated in FIG. 8, a circumferential edge portion of the casing cover portion 12 is fixed to a circumferential edge portion of the opening portion 111 with a bolt 125, and the opening portion 111 is closed.

FIG. 7 is a cross-sectional view taken along line A-A of FIG. 4. FIG. 8 is an enlarged cross-sectional view illustrating the automatic transmission 1 with the control device unit installation structure for a transmission according to one embodiment of the disclosure. Further, in FIG. 7, illustration of a hydraulic control valve or the like which controls an oil pressure supplied to the transmission mechanism 20 is omitted for convenience of explanation.

As illustrated in FIG. 7, in the machinery compartment 40, the transmission mechanism 20 is accommodated in a transmission case 102. A hydraulic control body 103 (refer to FIG. 8 or the like) is installed in the transmission case 102. The hydraulic control body 103 includes the hydraulic control valve (not illustrated) and so on which controls the oil pressure supplied to the transmission mechanism 20, oil discharged from an oil pump (not illustrated) is supplied to the hydraulic control body 103, and the hydraulic control valve is controlled on the basis of a signal for opening and closing the hydraulic control valve. One end of a harness 104 (refer to FIG. 3 or the like) is electrically connected to the hydraulic control valve and sensors such as a hydraulic pressure sensor, a rotation sensor, and so on. The harness 104 is disposed to extend along the hydraulic control body 103, and the other end of the harness 104 is bundled by a terminal (hereinafter, referred to as a “control body side terminal 106”) of a lumped coupler 105. As illustrated in FIG. 8, the lumped coupler 105 is fixed to the hydraulic control body 103 by a bolt 1031.

An oil strainer (strainer) 51 is installed at a lower side of the hydraulic control body 103 inside the oil pan compartment 50. The oil strainer 51 has a suction port 511 in a lower surface thereof. The suction port 511 suctions the ATF accumulated in a bottom portion of the oil pan compartment 50 into the oil strainer 51. A position of the suction port 511 in the oil strainer 51 is located at an optimum position in consideration of forward, backward, leftward and rightward acceleration during traveling of the vehicle 100.

A control device unit 60 (hereinafter, referred to as a “transmission control unit (TCU) 60”) controls the automatic transmission 1 by controlling the oil pressure of the ATF with the hydraulic control device (not illustrated) of the hydraulic control body 103. As illustrated in FIG. 8 or the like, the TCU 60 has an electronic substrate 63, a case 61 and a TCU side terminal 62. The electronic substrate 63 which is not illustrated is accommodated in the case 61, and the electronic substrate 63 is electrically connected to the TCU side terminal 62 which is connectable to the control body side terminal 106 of the lumped coupler 105. The harness 104 is electrically connected to the electronic substrate 63 of the TCU 60 by engaging the control body side terminal 106 of the lumped coupler 105 with the TCU side terminal 62. Further, as illustrated in FIG. 8, the TCU 60 is directly installed and fixed to the casing cover portion 12 by a bolt 65.

As illustrated in FIG. 7, a breather device 70 is provided on an upper portion of the casing 10. The breather device 70 has a breather chamber 71 and a connecting portion 72. In an internal space of the breather chamber 71, the breather chamber 71 performs gas-liquid separation to separate out air mixed with the ATF (hereinafter, referred to as “ATF mixed air”) as lubricating oil sprayed into the transmission. The connecting portion 72 is connected to the casing 10, has a communication port communicating with an inside of the casing 10 and allows the ATF mixed air to flow to an internal space of the breather chamber 71 through the communication port. That is, in the breather device 70, breather blowing due to deterioration of defoaming performance of the ATF in the casing 10 or the like is prevented, and ventilation between an inside and an outside of the casing 10 is performed through the connecting portion 72 of the breather device 70 and the breather chamber 71.

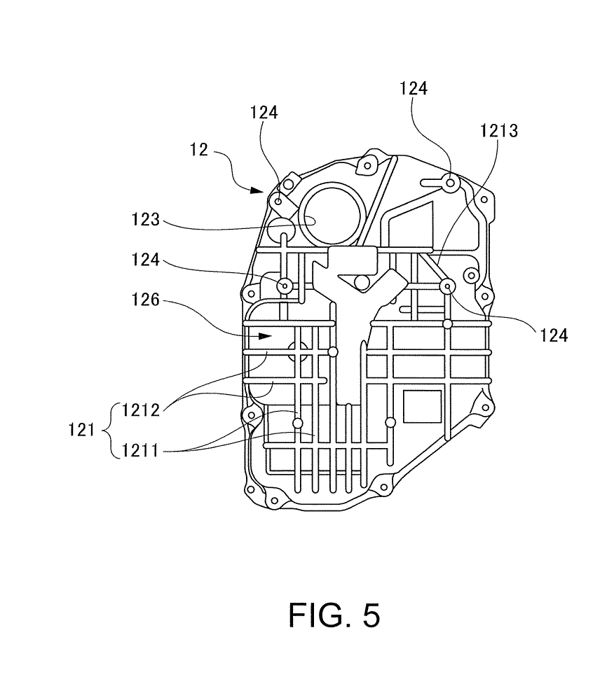

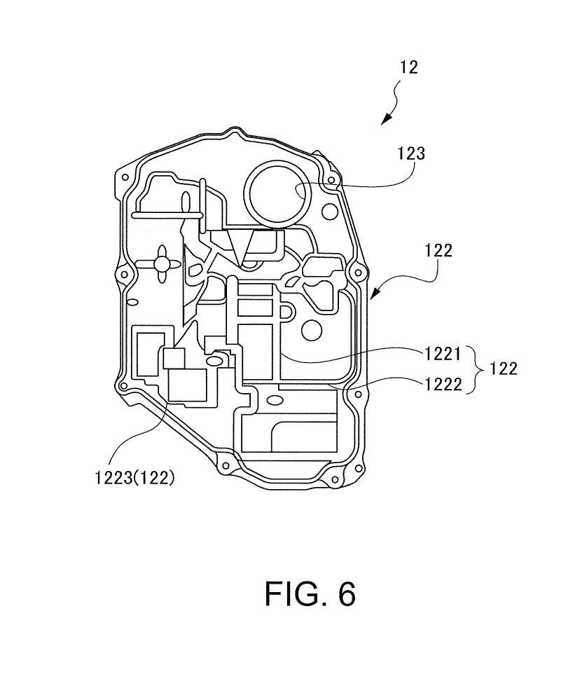

Next, the casing cover portion 12 will be described in detail with reference to FIG. 5 and FIG. 6. FIG. 5 is a front view illustrating the casing cover portion 12 of the automatic transmission 1 with the control device unit installation structure for a transmission according to one embodiment of the disclosure. FIG. 6 is a rear view illustrating the casing cover portion 12 of the automatic transmission 1 with the control device unit installation structure for a transmission according to one embodiment of the disclosure.

As illustrated in FIGS. 5 and 6, the casing cover portion 12 has substantially an oval shape which is longer in a vertical direction when seen from the front. An outer surface of the casing cover portion 12 has a protruding portion 126 which protrudes forward in a central portion, and an inner surface of the casing cover portion 12 is recessed forward by an amount corresponding to the protruding portion 126 protruding. That is, for example, the casing cover portion 12 as a whole has a shape which protrudes outward and curves like a shape obtained by cutting away a part of a spherical shape.

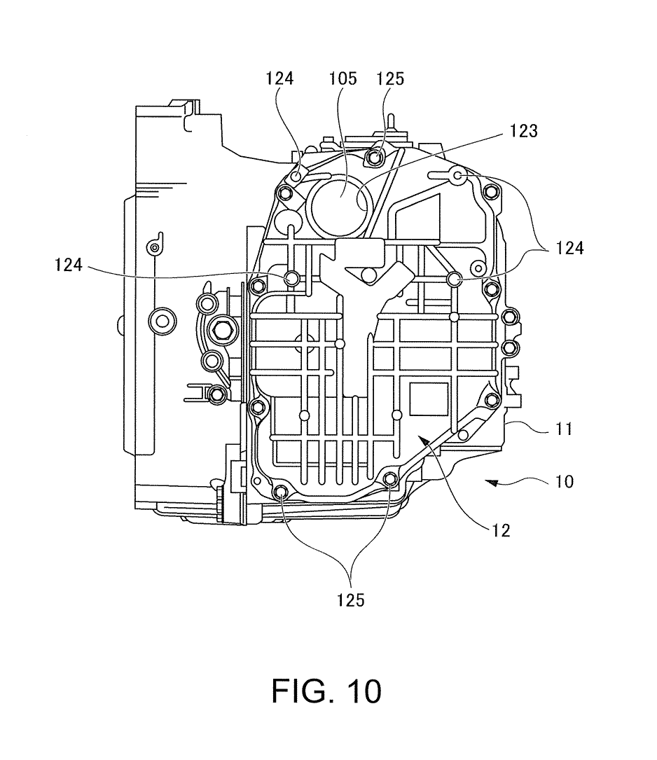

Further, as illustrated in FIG. 5, a through-hole 123 is formed in an upper left portion of the casing cover portion 12. The through-hole 123 has a circular shape when seen from the front. In the through-hole 123, as illustrated in FIG. 10, the lumped coupler 105 is inserted from an inner surface side of the casing cover portion 12 toward an outer surface side thereof, and the through-hole 123 is closed, and the TCU side terminal 62 is connected to the control body side terminal 106 (refer to FIG. 8) of the lumped coupler 105 from an outer surface side of the casing cover portion 12. As illustrated in FIG. 8, the lumped coupler 105 and a circumferential edge portion of an opening portion of the casing cover portion 12 forming the through-hole 123 are liquid-tightly sealed by a ring seal 1051.

As illustrated in FIGS. 5 and 6, ribs 121 and ribs 122 are formed on the outer surface and the inner surface of the casing cover portion 12. The ribs 121 on the outer surface of the casing cover portion 12 include vertical ribs 1211 which protrude forward and extend vertically along the outer surface of the casing cover portion 12, horizontal ribs 1212 which extend in leftward and rightward directions of the vehicle 100, and other ribs 1213 (obliquely extending ribs and so on).

That is, the vertical ribs 1211 and the horizontal ribs 1212 are provided in a lattice pattern in both a region of a portion of the outer surface of the casing cover portion 12 in which the protruding portion 126 exists and a region of a portion thereof in which the protruding portion 126 is not provided. Further, on the outer surface of the casing cover portion 12, the vertical ribs 1211 and the horizontal ribs 1212 are provided to extend around a predetermined region to surround the predetermined region.

The ribs 121 on the outer surface of the casing cover portion 12 constitute reinforcing ribs which increase rigidity of the casing cover portion 12. Further, the ribs 121 on the outer surface of the casing cover portion 12 protrude in the forward direction of the vehicle and constitute heat radiating ribs in the casing cover portion 12.

The ribs 122 on the inner surface of the casing cover portion 12 protrude rearward and are provided to extend around a predetermined region (for example, a region of the inner surface of the casing cover portion 12 with respect to the region in which the vertical ribs 1211 and the horizontal ribs 1212 are provided in a lattice pattern on the outer surface of the casing cover portion 12) to surround the predetermined region.

More specifically, as illustrated in FIG. 6, the ribs on the inner surface include vertical ribs 1221 which extend vertically, horizontal ribs 1222 which extend in the leftward and rightward directions of the vehicle 100, and other ribs 1223 (curved ribs, obliquely extending ribs and so on), and the vertical ribs 1221 and the horizontal ribs 1222 are arranged around a predetermined region so that the predetermined region is surrounded by the vertical ribs 1221 and the horizontal ribs 1222. Therefore, the horizontal ribs 1222 cause a falling time of the ATF flowing down along the inner surface of the casing cover portion 12 to be longer. Thus, a time during which the air mixed into the ATF of the falling liquid is discharged from the ATF is made longer, an amount of air mixed into the ATF is reduced, and aeration toughness is improved.

Furthermore, as illustrated in FIG. 7, the curved rib 1223 located in the vicinity of the connecting portion 72 of the breather device 70 in an upper portion of the casing cover portion 12 extends along an edge portion of the casing cover portion 12 and also extends in a rearward direction of the vehicle 100. Also, the horizontal ribs 1222 located on a lower side of the connecting portion 72 of the breather device 70 in a middle portion of the casing cover portion 12 extend in the leftward and rightward directions of the vehicle 100 and also extend in a rearward direction of the vehicle 100. The ATF scattered from a vicinity of the inner surface of a portion from the middle portion of the casing cover portion 12 to a lower portion thereof toward the connecting portion 72 of the breather device 70 in the internal space of the casing 10 collides with the curved ribs 1223 and the horizontal ribs 1222, and thus scattering of the ATF toward the connecting portion 72 of the breather device 70 is minimized.

The ribs 122 on the inner surface of the casing cover portion 12 constitute reinforcing ribs which enhance the rigidity of the casing cover portion 12. Further, the ribs 122 on the inner surface of the casing cover portion 12 constitute ribs for gas-liquid separation which promote gas-liquid separation of the ATF mixed air by being in contact with the ATF mixed air over a wider area and suppress blowing-up from the breather device 70 (so-called breather blowing in the breather device 70).

A portion around the through-hole 123 on the outer surface of the casing cover portion 12 constitutes a TCU fixing portion which fixes the TCU 60 to the outer surface of the casing cover portion 12. In the TCU fixing portion, four screw holes 124 which allow the TCU 60 to be fixed with bolts 65 are formed. In addition, the through-hole 123 is located in a central portion of the TCU fixing portion. By fixing the TCU 60 to the TCU fixing portion, the TCU side terminal 62 is coupled to the control body side terminal 106 of the lumped coupler 105 inserted into the through-hole 123 on the casing cover portion 12, and thus the harness 104 is electrically connected to the electronic substrate 63 of the TCU 60.

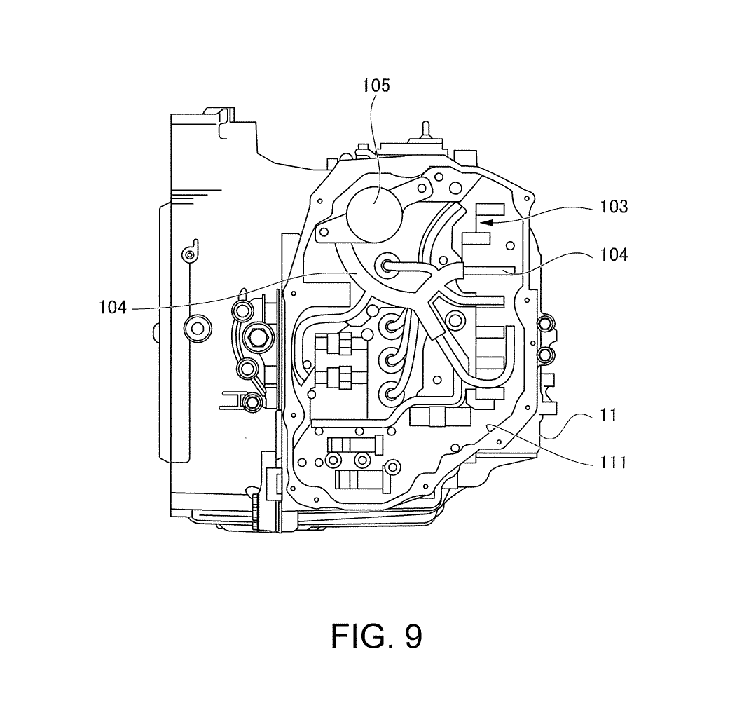

An installation of the control device unit in the automatic transmission 1 having the control device unit installation structure for a transmission having the above-described configuration will be described with reference to FIGS. 9 and 10.

FIG. 9 is a rear view illustrating a state before the casing cover portion and the TCU of the automatic transmission with the control device unit installation structure for a transmission according to one embodiment of the disclosure are installed. FIG. 10 is a rear view illustrating a state in which the casing cover portion is installed in the automatic transmission with the control device unit installation structure for a transmission according to one embodiment of the disclosure but the TCU is not yet installed.

First, as illustrated in FIG. 9, the hydraulic control body 103 is installed in the transmission case 102 disposed in an internal space of the casing wall portion 11 in a state in which the casing cover portion 12 is not installed on the casing wall portion 11, and thus one end of the harness 104 is electrically connected to the hydraulic control valve or the like, and the control body side terminal 106 of the lumped coupler 105 is installed at the other end of the harness 104.

Next, the lumped coupler 105 is inserted into the through-hole 123 of the casing cover portion 12, and the through-hole 123 is closed as illustrated in FIG. 10. Additionally, the casing cover portion 12 is fixed to the casing wall portion 11 by a bolt 113, and the casing 10 in which the casing wall portion 11 is fixed to the casing cover portion 12 is assembled. At this time, in the through-hole 123, the lumped coupler 105 is exposed on the outer surface side of the casing cover portion 12.

Next, the TCU 60 is brought closer from the outer surface side of the casing cover portion 12 to a position facing the through-hole 123 of the casing and the cover portion 12, and the TCU side terminal 62 is coupled to the control body side terminal 106 (refer to FIG. 8) of the lumped coupler 105. Therefore, the TCU 60 is fixed to the casing wall portion 11 through the casing cover portion 12.

According to the embodiment, the following effects are obtained.

In the control device unit installation structure for a transmission according to the embodiment, the TCU 60 as the control device unit of the automatic transmission 1 is directly mounted on the casing 10 as the outer wall of the automatic transmission 1 of the vehicle 100, and the harness 104 connected to the hydraulic control valve or the like serving as a functional part inside the automatic transmission 1 is electrically connected to the TCU 60.

The control device unit 60 is installed on the casing cover 12 forming a part of the casing 10. The harness 104 is coupled to the TCU 60 on the casing cover portion 12 via the lumped coupler 105 installed in the automatic transmission 1.

Accordingly, it is possible to electrically connect the lumped coupler 105 and the TCU 60 without using the harness 104. Therefore, the harness 104 is covered with the casing cover portion 12, and thus it is possible to protect the harness 104 from flying stones or the like.

Further, the ribs 121 and ribs 122 for reinforcing the casing cover portion 12 are formed on the inner surface and the outer surface of the casing cover portion 12, respectively. Therefore, the rigidity of the casing cover portion 12 can be increased. This suppresses the TCU 60 fixed to the casing cover portion 12 from greatly vibrating together with the casing cover portion 12. Therefore, it is possible to suppress wear of the TCU side terminal 62 connected to the lumped coupler 105 vibrating together with the automatic transmission 1 and the hydraulic control body 103 due to film surface vibration of the casing cover portion 12.

Further, the ribs 121 formed on the outer surface of the casing cover portion 12 constitute the heat radiating ribs in the casing cover portion 12. Therefore, it is possible to efficiently discharge the heat in the internal space of the casing 10 to the outside of the casing cover portion 12. In particular, since the casing cover portion 12 is provided in the opening portion 111 which opens in the forward direction of the vehicle 100 at the front portion of the casing wall portion 11, the air flowing from a front of the vehicle 100 to a rear thereof is likely to flow through the ribs 121, and thus an effective cooling effect can be obtained.

Further, the reinforcing ribs 122 formed on the inner surface of the casing cover portion 12 constitute ribs for gas-liquid separation of the ATF and ribs for preventing blowing-up. Therefore, it is possible to lengthen the time during which the ATF scraped up by the transmission mechanism 20 and mixed with air flows along the inner surface of the casing wall portion 11, and thus it is possible to reduce the amount of air mixed into the ATF. Further, since the ATF mixed air is in contact with the rib 122 before directly flowing into the breather device 70, it is possible to promote the gas-liquid separation of the ATF mixed air. Therefore, the so-called breather blowing is effectively prevented from occurring, and thus the breather robustness can be improved.

Further, the disclosure is not limited to the above-described embodiment, and variations, improvements or the like within the scope of achieving the object of the disclosure are included in the disclosure.

For example, although the ribs 121 and the ribs 122 are formed on the outer surface and the inner surface of the casing cover portion 12, the disclosure is not limited to this configuration. The ribs may be formed on at least one of the inner surface and the outer surface of the cover. Further, the ribs for gas-liquid separation may or may not serve as the ribs for preventing blowing-up.

Furthermore, the configuration of each part of the control device unit installation structure for a transmission is not limited to the configuration of each part of the control device unit installation structure for a transmission in the embodiment. Specifically, for example, the configurations of the cover, the lumped coupler, the ribs, and so on are not limited to the configurations of the casing cover portion 12, the lumped coupler 105 and the ribs 121 and 122 in the embodiment.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A control device unit installation structure for a transmission in which a control device unit of the transmission of a vehicle is directly mounted on an outer wall of the transmission and a harness connected to a functional part inside the transmission is electrically connected to the control device unit,
wherein the control device unit is installed on one cover forming a part of the outer wall, and
the harness is coupled to the controller device unit on the one cover via a lumped coupler installed in the transmission.

2. The control device unit installation structure according to claim 1, wherein reinforcing ribs of the cover are formed on at least one of an inner surface and an outer surface of the cover.

3. The control device unit installation structure according to claim 2, wherein the reinforcing ribs formed on the outer surface of the cover constitute heat radiating ribs of the cover.

4. The control device unit installation structure according to claim 2, wherein the reinforcing ribs formed on the inner surface of the cover constitute ribs for gas-liquid separation of lubricating oil and/or ribs configured to prevent blowing-up.
